(19) United States
(12) Patent Application Publication
(10) Pub. No.: US 2012/0208402 A1
(43) Pub. Date: Aug. 16, 2012

(54) Terminal Module And Method For Manufacturing The Same

(76) Inventors: Gang LEE, Shanghai (CN); Huibin LI, Shanghai (CN); Wei YAO, Shanghai (CN); Chih Hsieh CHANG, Taipei (TW)

(21) Appl. No.: 13/370,866

(22) Filed: Feb. 10, 2012

(30) Foreign Application Priority Data
Feb. 12, 2011 (CN) 201110037950.8

(51) Int. Cl. H01R 24/00; H01R 43/20

(52) U.S. Cl. 439/626; 29/876

(57) ABSTRACT

The invention is a terminal module and a method for manufacturing the same. The terminal module includes an insulating body and a plurality of first and second terminals. The plurality of first and second terminals are alternatively arranged side by side and partially insert-molded within the insulating body. The plurality of first terminals and the plurality of second terminals are connected to a common terminal carrier.

### CROSS-REFERENCE TO RELATED APPLICATION

This application claims the benefit of the filing dates under 35 U.S.C. §119(a)-(d) of Chinese Patent Application No. 201110037950.8, filed on Feb. 12, 2011,

### FIELD OF INVENTION

The invention relates to an electrical connector and, more particularly, to a terminal module for manufacturing an electrical connector.

### BACKGROUND

Electrical connectors such as USB connectors and HDMI electrical connectors are commonly used in the communications field of technology. A critical factor to obtain a competitive position in the market is to reduce the manufacturing cost of an electrical connector.

A terminal module is a key component in an electrical connector, which generally includes an insulating body and a plurality of terminals partly supported in the insulating body. Most of the terminal modules in the electrical connectors include two groups of terminals, The two groups of terminals typically come from different terminal carriers. Therefore, in the manufacturing process of the terminal module, it is necessary to machine two groups of terminals respectively and then insert-mold and fix one group of terminals with plastic by way of a molding process, during which terminal holes are formed in the plastic in advance. After the molding process, the second group of terminals are inserted into the terminal holes formed in advance respectively, so as to form a terminal module having two groups of terminals. Then, the manufactured terminal module and the other components are assembled together in a casing of an electrical connector to form the electrical connector.

With the above described known terminal module and method for manufacturing the same, there are disadvantages. For instance, the amount of waste in these known processes is high, notably the terminal carrier, which results in high manufacturing cost of an electrical connector.

### SUMMARY

It would be advantageous to provide a terminal module and a method for manufacturing the same, capable of overcoming at least one of the disadvantages of the prior art and reducing the manufacturing cost of an electrical connector.

The terminal module includes an insulating body and a plurality of first and second terminals. The plurality of first and second terminals are alternatively arranged side by side and partially insert-molded within the insulating body. The plurality of first terminals and the plurality of second terminals that connect to a common terminal carrier.

### BRIEF DESCRIPTION OF THE DRAWINGS

The objects, features and advantages of the invention will become more apparent by describing in detail embodiments thereof with reference to the accompanying drawings, in which:

FIG. 1A is a top perspective view of a terminal module according to the invention;

FIG. 1B is a bottom perspective view of the terminal module shown in FIG. 1A;

FIG. 2A is a perspective view of a terminal portion of the terminal module of FIG. 1B;

FIG. 2B is a plan view of the terminal portion shown in FIG. 2A;

FIG. 2C is a side view of the terminal portion shown in FIG. 2A;

FIG. 3A is a perspective view of another terminal module according to the invention;

FIG. 3B is a plan view of the terminal module shown in FIG. 3A;

FIG. 3C is a side view of the terminal module shown in FIG. 3A;

FIG. 4A is a perspective view of a terminal portion of the terminal module shown in FIG. 3A;

FIG. 4B is a plan view of the terminal portion shown in FIG. 4A; and

FIG. 4C is a side view of the terminal portion shown in FIG. 4A.

### DETAILED DESCRIPTION OF THE EMBODIMENT(S)

The embodiments of the present invention will be described by way of examples with reference to the accompanying drawings. From the following embodiments, a person skilled in the art would easily understand the configurations and advantages of the present invention. However, it should be appreciated that the drawings and the detailed embodiments are just for the purpose of explaining the configurations and principle of the present invention, but not for limiting the invention.

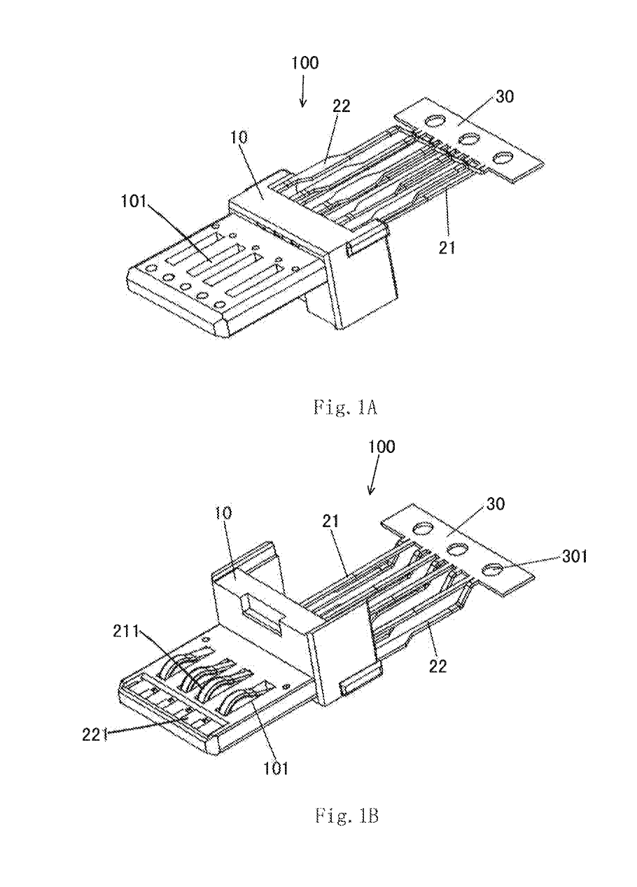

As shown in FIGS. 1A and 1B, the terminal module 100 comprises an insulating body 10, a plurality of first terminals 21, and a plurality of second terminals 22 partly supported by the insulating body 10. Each of the first terminals 21 and the second terminals 22 includes a first end projecting from the insulating body 10 and connected with a carrier 30. The first end constitutes a soldering portion for soldering onto a PCB. Each of the first terminals 21 and the second terminals 22 further includes a second end disposed in the insulating body 10. The second ends of the first terminals and the second terminals 22 include contact portions 211 and 221 exposed from the insulating body 10 respectively, for electrical connection with the contact portions of a matching connector. Further, as shown in FIG. 1B, the contact portions 211 of the first terminals 21 are received in openings 101 formed in the insulating body 10 and movable elastically in the openings 101.

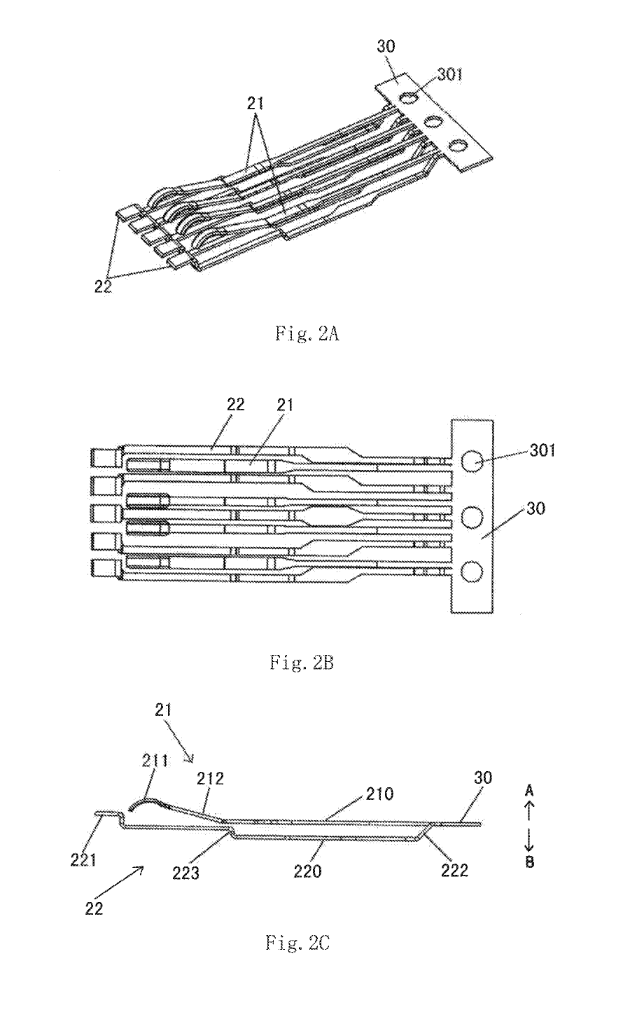

As shown in FIGS. 2A-2C, the terminal portion includes a carrier 30 of rectangular shape and the plurality of first terminals 21 and the plurality of second terminals 22 extending from the rectangular carrier 30. In the embodiment shown, the first terminals 21 include four terminals and the second terminals 22 include five terminals. The first terminals 21 and the second terminals 22 are alternatively arranged and extend from a common carrier 30. In the embodiment shown, the first terminals 21 are USB2.0 terminals and the second terminals 22 are USB3.0 terminals. The carrier 30 has three fitting holes 301 for engaging fitting parts of a transportation tool, during transportation of the terminals so as to facilitate transportation of the terminals.

According to an alternative embodiment of the invention, the number of the first terminals 21 and the second terminals 22 can be changed, and the first terminals 21 may be USB3.0 or other high speed terminals and the second terminals 22 may be USB2.0 or other low speed terminals.

In the embodiment shown in FIGS. 2A-2C, the first terminals 21 and the second terminals 22 have different lengths. Specifically, the length of the second terminals 22 is longer than the length of the first terminals 21. Further, as shown particularly in FIG. 2C, the first terminals 21 and the second terminals 22 are disposed substantially in different planes, and the first terminals 21 are disposed substantially above the second terminals 22. By arranging the first terminals and the second terminals in such a way, during the molding process in which the terminal portion are overmolded in the insulating body 10 to form the terminal module 100, it is convenient to distinguish the high speed terminals and the low speed terminals and able to avoid the interference between the high speed terminals and the low speed terminals.

Further, as shown in FIGS. 2A and 2B, the high speed terminals and the low speed terminals are manufactured from the same terminal carrier. The high speed terminals and the low speed terminals are arranged alternatively. In this way, the material waste in interval portions between the terminals occurred when the high speed terminals and the low speed terminals are manufactured separately as in the prior art can be avoided, so that the material of the terminal carrier can be saved.

As shown in FIGS. 2A-2C, each of the first terminals 21 includes an arm 210 and a contact portion 211. The arm 210 extends from the carrier 30 and the contact portion 211 is formed at the end of the arm 210. Likewise, each of the second terminals 22 includes an arm 220 and a contact portion 221. The arm 220 extends from the carrier 30 and the contact portion 221 is formed at the end of the arm 220.

Further, as shown in FIG. 2C, the arm 210 of each of the first terminals 21 may include an inclined portion 212 bent in a first direction A perpendicular to the plane of the carrier 30. The inclined portion 212 is positioned near the contact portion 211. The arm 220 of each of the second terminals 22 may include an inclined portion 222 bent in a second direction B opposite to the first direction A. The inclined portion 222 is positioned near the carrier 30. The arm 220 of each of the second terminals 22 may further include a bent portion 223 bent in the first direction A. The bent portion 223 is positioned near the contact portion 221. By configuring the first terminals and the second terminals in such a way, the first terminals and the second terminals can be spaced or separated from each other in a direction perpendicular to the plane of the carrier 30, and be compactly arranged in space.

As shown in FIG. 2C, the contact portion 211 of each of the first terminals 21 is shaped as an arc shape, and the contact portion 221 of each of the second terminals 22 is formed as a inclined portion bent at a right angle. Alternatively, the contact portions may have other suitable shapes.

As mentioned above, the contact portion 211 of the first terminals 21 elastically deform within the opening 101 in a direction perpendicular to the plane of the carrier 30. The first terminals 21 and the second terminals 22 do not interfere with each other in the terminal module 100.

The processes for manufacturing the terminal module 100 are described below, Which includes stamping and forming the carrier 30, the plurality of first terminals 21, and the plurality of second terminals 22 as shown in FIG. 2A-2C from the same terminal carrier by mechanical processing.

First, a terminal carrier of suitable specification is chosen and then stamped into terminals: firstly stamping the front regions of the USB 3.0 terminals and the USB 2.0 terminals as shown in FIGS. 2A and 2B according to a terminal design, then stamping the middle regions of the respective terminals, and finally, cutting the rear regions of the respective terminals. When stamping the rear regions of the terminals, scores are located in advance for breaking in a later process. After the above stamping processes are finished in order, a plurality of terminals are obtained which are substantially divided from one another with one ends of the terminals connected with a common uncut carrier 30. The uncut carrier 30 serves to maintain the relative position of the respective terminals.

Then, the terminals after the stamping processes are formed by the following steps: firstly, bending and shaping the front portions of the USB2.0 terminals to obtain arc-shaped contact portions as desired and bending and shaping the front portions of the USB3.0 terminals to obtain contact portions bent at a right angle as desired; then, bending and shaping the arms of the USB2.0 terminals to obtain a desired arm shape and bending and shaping the arms of the USB3.0 terminals to obtain a desired arm shape. While bending and shaping the rear ends of the arms of the respective terminals, the scores formed previously are broken simultaneously.

After the above manufacturing processes, the terminal portions as shown in FIGS. 2A-2C are formed, in which each of the USB2.0 terminals is interposed between two adjacent USB3.0 terminals and is movable up and down freely and elastically in a deform direction and does not interfere and overlap with the USB3.0 terminals. The rear ends of all the terminals are connected to the same carrier 30 so that subsequent manufacturing processes can be conducted easily.

After stamping and forming the terminal portion shown in FIGS. 2A-2C, a molding process is preformed. The molding process includes insert-molding and fixing the plurality of first terminals 21 and the plurality of second terminals 22 with plastic to form a terminal module 100 as shown in FIGS. 1A-1B. Once set, the insulating body 10 supports the first terminals 21 and second terminals 22. The first end of each of the first terminals 21 and the second terminals 22 projects from the insulating body 10. The second end of each of the first terminals 21 and the second terminals 22 is disposed in the insulating body 10 and includes contact portions 211 and 221 exposed from the insulating body 10

During the molding process, openings 101 are formed in the insulating body 10 for receiving the contact portions 211 of the first terminals 21 such that the contact portions 211 are deformable elastically within the openings 101.

According to the above embodiment, during the stamping process, the terminal carrier is cut substantially along a line so as to form the respective terminals extending therefrom, wherein the first ends of the respective terminal are connected with the carrier 30 while the second ends of the respective terminals are separate from one another.

According to the discussed embodiment, during the steps of bending and shaping the terminals, preferably, the first terminals and the second terminals are bent and shaped in opposite directions perpendicular to the plane of the terminal carrier such that the first terminals and the second terminals are disposed substantially in different planes.

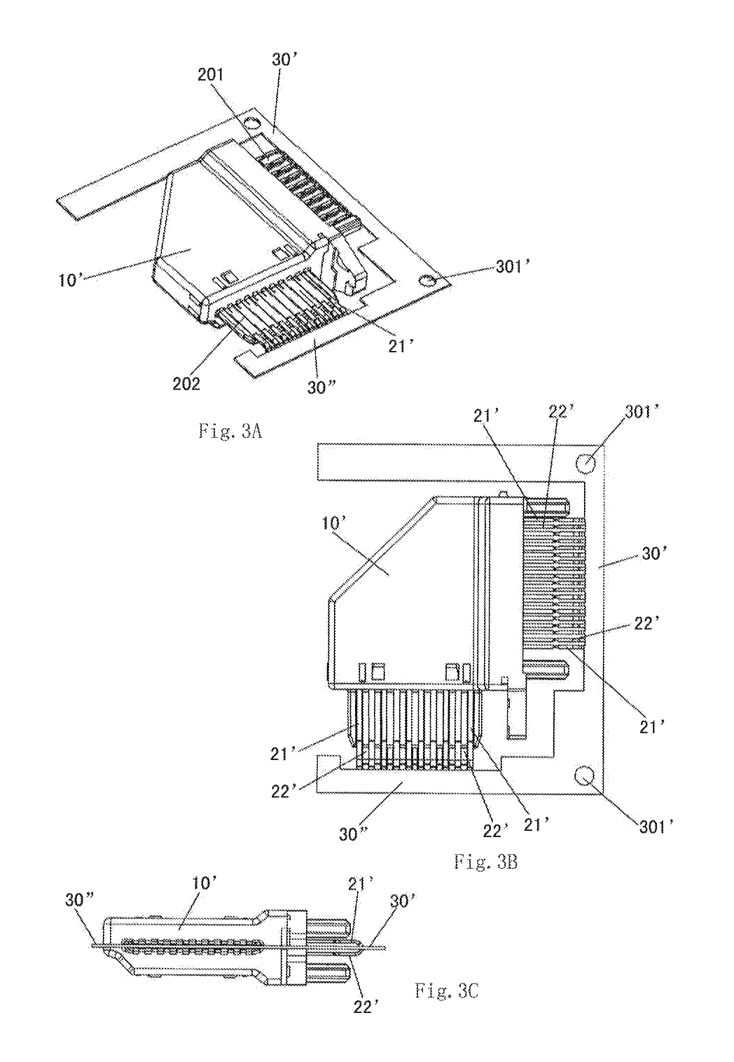

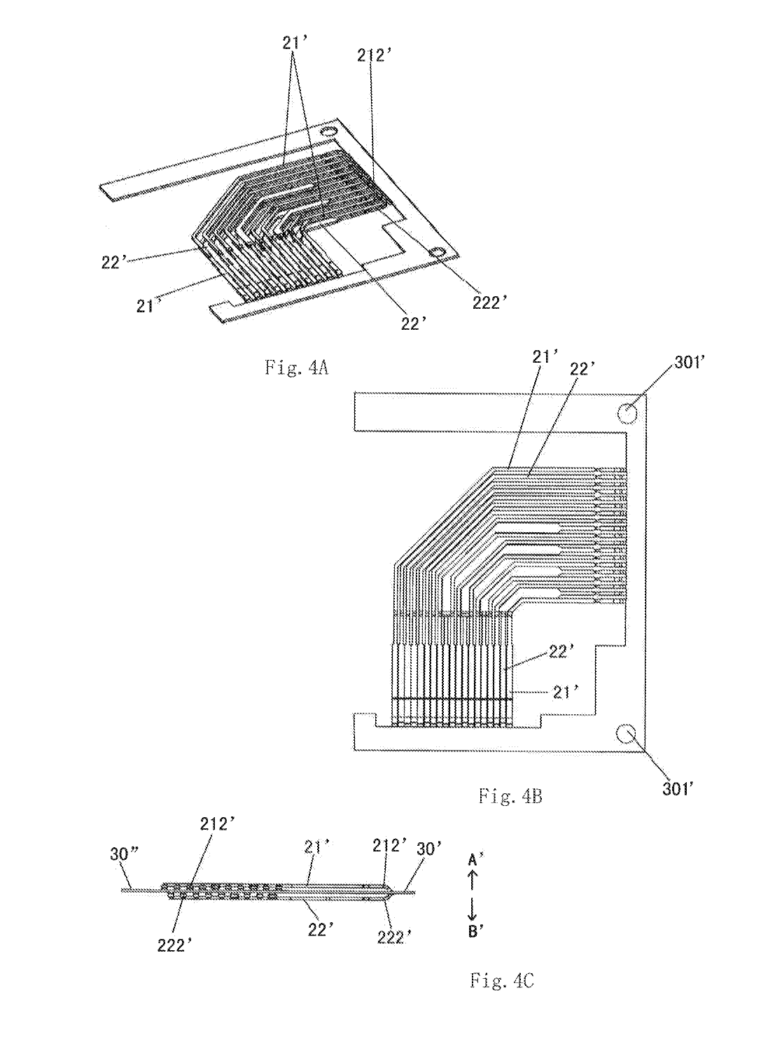

Now with reference to FIGS. 3A-4C, another terminal module 100′ according to the invention is shown.

As shown in FIGS. 3A and 3C, the terminal module 100′ includes an insulating body 10′, and a plurality of first terminals 21′ and a plurality of second terminals 22′ partly supported by the insulating body 10′. Each of the first terminals 21′ and the second terminals 22′ includes a first end 201 projecting from the insulating body 10′ and connected with a first carrier 30′. For example, the first end 201 may serve as a soldering portion for soldering onto a PCB. Each of the first terminals 21′ and the second terminals 22′ further includes a second end 202 projected from the insulating body 10′ and connected with a second carrier 30″. For example, the second end 202 may be connected to a contact portion of a matching electrical connector. As shown in FIGS. 3A-3B, the first end 201 and the second ends 202 of the first terminals 21′and the second terminals 22′ project from the insulating body 10′substantially in perpendicular directions and connect to the carrier 30′ and 30″ respectively.

FIGS. 4A-4C show views of the terminal portion included in the terminal module as shown in FIGS. 3A-3C. As shown in FIGS. 4A-4C, the terminal portion includes the first terminals 21′ and the second terminals 22′ extending substantially at a right angle. Two ends of the first terminals 21′ and the second terminals 22′ are connected to the carriers 30′and 30″ respectively. The first terminals 21′ in this embodiment include ten terminals and the second terminals 22′ in this embodiment include nine terminals. The first terminals 21′and the second terminals 22′are arranged alternatively and extend between the carrier 30′and the carrier 30″ and are disposed substantially on the upper side and lower sides of the plane of the terminal carrier respectively. Both of the first terminals and the second terminals are HDMI high speed terminals. The carrier 30′ has two fitting holes 301′ therein for engaging with fitting parts of a tooling or machinery that facilitate motion of the carrier and terminals during manufacturing. According to the shown embodiment, the two ends of the terminal portion are connected to the two carriers respectively so that the terminals can be stably positioned relative to one another during subsequent manufacturing processes.

As shown in FIGS. 3C and 4C, the first terminals 21′ and the second terminals 22′ are disposed substantially in different planes on two sides of the plane of the terminal carrier, and the first terminals 21′are disposed substantially above the second terminals 22′. The first terminals and the second terminals are disposed in a way, such that the terminal portion may be insert-molded in the insulating body 10′ by the molding process to form the terminal module 100′.

As shown in FIGS. 4A-4C, each of the first terminals 21′ includes two inclined portions 212′ formed near the carrier 30′ and the carrier 30″ respectively. Each of the inclined portions is bent in a first direction A′ perpendicular to the plane of the carriers 30′and 30″. Each of the second terminals 22′ includes two inclined portions 222′ formed in positions corresponding to the inclined portions 212′of the first terminals 21′. Each of the inclined portions 212′ is bent in a second direction B′ opposite to the first direction A′. In this way, the first terminals and the second terminals are substantially separated or spaced from each other in the direction perpendicular to the plane of the terminal carrier and disposed in two planes.

The processes for manufacturing the terminal module 100′ are similar as in the embodiment shown in FIGS. 1A-2C. Firstly, the terminal portion as shown in FIGS. 4A-4C is manufactured from the same terminal carrier by mechanical processing. The terminal portion includes the plurality of first terminals 21′ and the plurality of second terminals 22′ extended at a right angle with each other between the carrier 30′ and the carrier 30″ of the same terminal carrier. Then, the first terminals and second terminals are insert molded to form the terminal module 100′. In the terminal module 100′, the plastic constitutes the insulating body 10′ supporting the two groups of terminals, and the two ends of the first terminals 21′ and the second terminals 22′ project from the insulating body 10′ and connect to the carriers 30′ and 30″ respectively.

The mechanical processing includes the steps of: stamping the terminal carrier to divide the terminal carrier into the first terminals 21′and the second terminals 22′arranged alternatively, and leaving the carriers 30′and 30″ uncut for maintaining the relative position of the first terminals 21′and the second terminals 22′; and then bending and shaping the first terminals 21′and the second terminals 22′ respectively to form a desired terminal shape. Specifically, the first terminals 21′and the second terminals 22′ are bent and shaped in opposite directions perpendicular to the plane of the terminal carrier respectively, so that the first terminals 21′ and the second terminals 22′ are disposed substantially in different planes.

According to the embodiment shown, during the process of stamping the terminal carrier, it is cut substantially at a right angle to form the first terminals 21′ and the second terminals 22′ that extend substantially at a right angle, and the first ends and the second ends of the first terminals 21′ and the second terminals 22′ are connected to the uncut carriers 30′ and 30″ of the same terminal carrier, respectively.

According to the above embodiment, during the molding process, the portions of the two groups of terminals bent at a right angle are insert-molded and fixed with plastic such that the first end and the second end of each of the first terminals 21′ and the second terminals 22′ project from the insulating body 10′ substantially in perpendicular directions,

As set forth above, with the terminal module of the present invention and the method for manufacturing the same, by arranging two groups of terminals alternatively in the same terminal carrier, the utilization rate of carrier material is increased. Further, by insert-molding and fixing two groups of terminals in a single molding process, the manufacturing processes can be reduced and thus the manufacturing cost of the terminal module can be reduced. Therefore, the manufacturing cost of the electrical connector can be reduced and the competitiveness of the final product can be improved.

The above embodiments just describe the principle and configuration of the present invention by way of examples rather than limiting the present invention. A person skilled in the art would appreciate that various modifications and changes made on the embodiments are all within the scope of the present invention which is defined in the claims.

What is claimed is:

1. A terminal module, comprising:
an insulating body, and
a plurality of first terminals and a plurality of second terminals alternatively arranged and partially insert-molded within the insulating body, the plurality of first terminals and the plurality of second terminals being connected to a terminal carrier.

2. The terminal module according to claim 1, wherein the plurality of first terminals and the plurality of second terminals are supported in the insulating body along different planes.

3. The terminal module according to claim 1, wherein each of the plurality of first terminals and the plurality of second terminals further includes an end disposed in the insulating body and has a contact portion exposed out of the insulating body.

4. The terminal module according to claim 3, wherein the plurality of first terminals and the plurality of second terminals further include another end connected to the terminal carrier.

5. The terminal module according to claim 1, wherein the plurality of first terminals and the plurality of second terminals include contact portions exposed through an opening in the insulating body.

6. The terminal module according to claim 5, wherein the contact portions are movable within the opening.

7. The terminal module according to claim 1, wherein each of the plurality of first terminals includes an arm that extends from the terminal carrier and a contact portion formed at an end of the arm.

8. The terminal module according to claim 1, wherein each of the plurality of second terminals includes an arm that extends from the terminal carrier and a contact portion formed at an end of the arm.

9. The terminal module according to claim 7, wherein the arm of each of the plurality of first terminals includes a first inclined, portion bent in a first direction perpendicular to a plane of the terminal carrier.

10. The terminal module according to claim 9, wherein the first inclined portion is positioned near the contact portion.

11. The terminal module according to claim 8, wherein the arm of each of the plurality of second terminals includes a second inclined section bent in a direction opposite to the first direction that the first inclined portion is bent.

12. The terminal module according to claim 11, wherein the second inclined section is positioned near the terminal carrier.

13. The terminal module according to claim 12, wherein the arm of each of the plurality of second terminals further include a bent portion bent in the first direction and positioned near the contact portion.

14. The terminal module according to claim 7, wherein the contact portion of each of the plurality of first terminals is are shaped.

15. The terminal module according to claim 8, wherein the contact portion of each of the plurality of second terminals is formed as an angled section having a right angle bend.

16. A method of manufacturing a terminal module, comprising the steps of:
stamping and forming a plurality of first terminals and a plurality of second terminals connected to a terminal carrier;
arranging the plurality of first terminals and the plurality of second terminals in alternating positions; and
insert-molding the plurality of first terminals and the plurality of second terminals within an insulating body.

17. The method of manufacturing a terminal module according to claim. 16, further including the step of:
stamping the terminal carrier to divide the terminal carrier into the plurality of first terminals and the plurality of second terminals in alternating arrangement and leaving a carrier uncut for maintaining a relative position of the plurality of first terminals and the plurality of second terminals.

18. The method of manufacturing a terminal module according to claim 17, further comprising the steps of:
bending and shaping the plurality of first terminals and the plurality of second terminals respectively.

19. The method of manufacturing a terminal module according to claim 18, further comprising the steps of:
bending and shaping the plurality of first terminals and the plurality of second terminals in opposite directions substantially perpendicular to a plane of the terminal carrier such that the plurality of first terminals and the plurality of second terminals are disposed substantially in different planes.

20. The method of manufacturing a terminal module according to claim 19, further comprising the step of:
providing openings in the insulating body such that contact potions of the plurality of first contacts are exposed through and elastically deformable within the openings of the insulating body.
